(19) United States
(12) Patent Application Publication
(10) Pub. No.: US 2026/0290777 A1
(43) Pub. Date: Sep. 24, 2026

(54) ION GUIDE, AND MASS SPECTROMETRY DEVICE PROVIDED WITH SAME

(71) Applicant: HITACHI HIGH-TECH CORPORATION, Tokyo (JP)

(72) Inventors: Masuyuki Sugiyama, Tokyo (JP); Hideki Hasegawa, Tokyo (JP); Yuichiro Hashimoto, Tokyo (JP)

(73) Assignee: HITACHI HIGH-TECH CORPORATION, Tokyo (JP)

(21) Appl. No.: 18/873,940

(22) PCT Filed: Jul. 13, 2023
(86) PCT No.: PCT/JP2023/025965

§ 371 Date: Dec. 11, 2024

(30) Foreign Application Priority Data
Aug. 23, 2022 (JP) 2022-132186

(51) Int. Cl. H01J 49/06

(52) U.S. Cl. CPC H01J 49/063

(57) ABSTRACT

In order to achieve an ion guide that has a simple structure, is resistant to contamination, and provides a wide m/z range of ions that can pass through the ion guide, the present disclosure proposes an ion guide into which ions are introduced and which is configured to focus and discharge the ions, the ion guide including a multipole electrode for forming a multipole electric field, and an axial field electrode for forming an axial electric field. The cross-sectional area perpendicular to the center axis of the ion guide of at least one of the multipole electrode or the axial field electrode varies from an inlet to an outlet of the ion guide (see FIG. 2A).

### TECHNICAL FIELD

The present disclosure relates to an ion guide and a mass spectrometry device provided with the same.

### BACKGROUND ART

Ion guides are widely used to transport ions in mass spectrometry devices. In particular, in an ion guide used in a collision cell of a tandem mass spectrometry device, it is necessary to generate an axial electric field on a center axis in order to prevent crosstalk. Regarding the axial electric field, for example, PTL 1 discloses generating an axial electric field that accelerates ions in a multipole ion guide including multipole (such as quadrupole) electrodes parallel to each other. PTL 2 discloses inserting an electrode of a resistive element to which a radio-frequency voltage is applied into a multipole electrodes to which a radio-frequency voltage is applied to generate an axial electric field.

### CITATION LIST

### Patent Literature

PTL 1: U.S. Pat. No. 5,847,386 A1
PTL 2: U.S. Pat. No. 8,785,847 B2

### SUMMARY OF INVENTION

### Technical Problem

However, the ion guide that applies an axial electric field by inclining a pair of rod electrodes as disclosed in PTL 1 has a problem of a decrease in the m/z range of ions that can pass through the ion guide. The ion guide in which an electrode is inserted into a gap between the rod electrodes as disclosed in PTL 2 has a complicated structure, has narrow spacing between the electrodes, and has a small surface area of the electrodes. Thus, such the ion guide has a problem that the performance is likely to decrease due to contamination of the electrodes by contaminants such as neutral droplets introduced into the ion guide. Furthermore, the ion guide disclosed in PTL 2 has a complicated configuration, has narrow spacing between the electrodes, and has a small surface area of the electrode for forming an axial electric field. For this reason, the ion guide disclosed in PTL 2 also has a problem that the performance is likely to decrease due to contamination of the electrodes by contaminants such as neutral droplets introduced into the ion guide.

In view of such circumstances, the present disclosure proposes a technology for achieving an ion guide having a wide m/z range of ions that can pass through the ion guide, having a simple structure, and resistant to contamination.

### Solution to Problem

In order to address the above problem, the present disclosure proposes an ion guide into which ions are introduced and which is configured to focus and discharge the ions, the ion guide including: a multipole electrode for forming a multipole electric field; and an axial field electrode for forming an axial electric field, wherein a cross-sectional area perpendicular to a center axis of the ion guide of at least one of the multipole electrode or the axial field electrode varies from an inlet to an outlet of the ion guide.

Further features related to the present disclosure will become apparent from the description of the specification and the accompanying drawings. In addition, embodiments of the present disclosure can be achieved and implemented by elements, a combination of a variety of elements, the following detailed description, and the appended claims. The description herein is merely exemplary and is not intended to limit the scope of the claims or application examples of the present disclosure in any way.

### Advantageous Effects of Invention

According to the technology of the present disclosure, it is possible to achieve an ion guide that has a simple structure, is resistant to contamination, and has a wide mass range of ions that are to pass therethrough, and a mass spectrometry device provided with the ion guide.

### BRIEF DESCRIPTION OF DRAWINGS

FIG. 1 is a cross-sectional view illustrating a schematic configuration example of a mass spectrometry device 10 provided with a curved ion guide 20 according to a first embodiment.

FIG. 2A is a diagram illustrating an external configuration example of the ion guide 20 according to the first embodiment.

FIG. 2B is a diagram illustrating a cross-sectional configuration example of the ion guide 20 along a center axis 23 according to the first embodiment.

FIG. 2C is a diagram illustrating a cross-sectional configuration example of an inlet 1A and an outlet 1B of the ion guide 20 according to the first embodiment.

FIG. 3 is a diagram illustrating a configuration example of an ion guide power supply 300 used in each embodiment.

FIG. 4 is a diagram illustrating a pseudo potential on a ry plane at the inlet 1A and the outlet 1B of the ion guide 20 according to the first embodiment.

FIG. 5 is a diagram illustrating a DC potential on an xz plane including the center axis 23 of the ion guide 20 according to the first embodiment.

FIG. 6 is a diagram illustrating a potential (function of θ in FIGS. 2 and 5) on the center axis 23 of the ion guide 20 according to the first embodiment.

FIG. 7 is a diagram illustrating a DC potential on a yr plane at the inlet 1A and the outlet 1B of the ion guide 20 according to the first embodiment.

FIG. 8 is a diagram illustrating the distribution of transmission times of 200 ions for each of conditions where the potential difference between an axial field electrode 22 and a multipole electrode 21 is 6 V, 3 V, 1.5 V, and 1 V.

FIG. 9 is a diagram illustrating the transmittance of ions having m/z of 150 to 4000 under conditions where the potential difference between the axial field electrode 22 and the multipole electrode 21 is 3 V and 6 V.

FIG. 10 is a diagram illustrating a schematic configuration example of an ion guide 201 according to a second embodiment.

FIG. 11 is a diagram illustrating a schematic configuration example of an ion guide 202 according to a third embodiment.

FIG. 12 is a diagram illustrating a configuration example of an ion guide 203 according to a fourth embodiment.

FIG. 13 is a diagram illustrating a configuration example of an ion guide 204 according to a fifth embodiment.

### DESCRIPTION OF EMBODIMENTS

The present embodiments describe achieving an ion guide having a wide m/z range of ions that can pass through the ion guide, having a simple structure, and resistant to contamination by varying at least one of a cross-sectional area (area of a surface perpendicular to an ion traveling direction) of a multipole electrode with respect to a center axis of the multipole electrode or a cross-sectional area of an axial field electrode with respect to a center axis of the axial field electrode from an inlet to an outlet of the ion guide.

The embodiments of the present disclosure will be described below with reference to the accompanying drawings. In the accompanying drawings, functionally same elements may be denoted by the same numbers. Note that, although the accompanying drawings provide specific embodiments and examples based on the principle of the present disclosure, they are provided for facilitating understanding of the present disclosure, and are never used to interpret the present disclosure in a limited way.

The embodiments provide description in sufficient detail for a person skilled in the art to embody the present disclosure, but it should be understood that other implementations and embodiments are possible, and changes in configurations or structures, or replacement of various elements are possible without departing from the scope and spirit of the technical idea of the present disclosure. Therefore, the following description should not be interpreted as being limited thereto.

### (1) First Embodiment

### <Configuration Example of Mass Spectrometry Device 10>

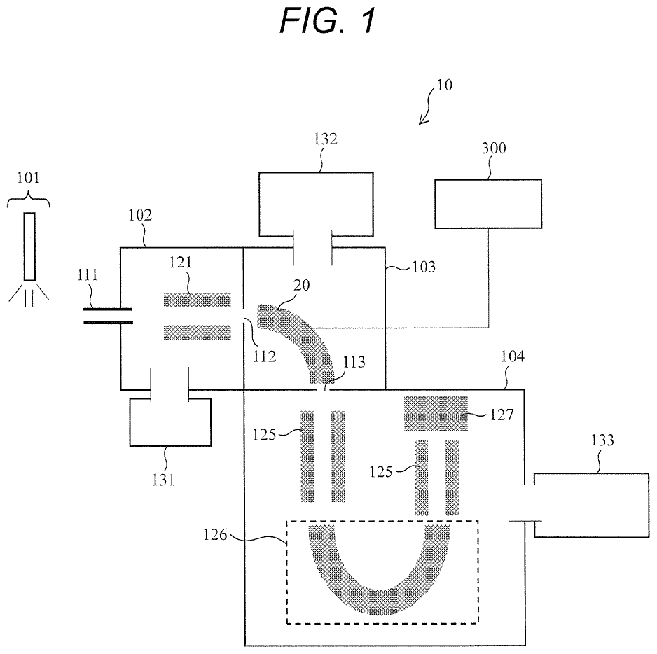

FIG. 1 is a cross-sectional view illustrating a schematic configuration example of a mass spectrometry device 10 provided with a curved ion guide 20 according to a first embodiment.

As an example, the mass spectrometry device 10 includes an ion source 101, a first differential pumping section 102 including an ion guide 121 for transporting ions as necessary, a vacuum pump 131 that exhausts air in the first differential pumping section 102 to generate vacuum, a second differential pumping section 103 including an ion guide (curved ion guide) 20, a vacuum pump 132 that exhausts air in the second differential pumping section 103 to generate vacuum, an ion guide power supply 300 that applies a voltage to the ion guide, a mass spectrometry chamber 104 including a mass filter 125, a collision cell 126, and a detector 127, and a vacuum pump 133 that exhausts air in the mass spectrometry chamber 104 to generate vacuum.

As the ion source 101, an electrospray ionization ion source, an atmospheric chemical ionization ion source, an atmospheric pressure photoionization ion source, an atmospheric pressure matrix-assisted laser desorption/ionization ion source, or the like can be used.

Ions generated by the ion source 101 pass through an aperture 111 provided in the first differential pumping section 102 together with the airflow and are introduced into the first differential pumping section 102 (vacuum chamber). The ions having passed through the differential pumping section 102 pass through an aperture 112 provided in a connection portion (wall) between the first differential pumping section 102 and the second differential pumping section 103, and are introduced into the ion guide 20 according to the technology of the present disclosure.

A voltage is applied to the ion guide 20 by the ion guide power supply 300. The pressure at which the ion guide 20 operates is about 1000 Pa to 10⁻³ Pa. In particular, at 1000 Pa to 0.1 Pa, kinetic energy of ions is cooled by collision with neutral gas molecules, so that ions can be efficiently focused. The ions discharged from the ion guide 20 pass through an aperture 113 provided in a connection portion (wall) between the second differential pumping section 103 and the mass spectrometry chamber 104, and are introduced into the mass spectrometry chamber 104.

When the mass spectrometry device 10 is, for example, a tandem mass spectrometry device, precursor ions of a specific m/z are selected by the mass filter 125 and dissociated in the collision cell 126 in the mass spectrometry chamber 104. The fragment ions generated in the collision cell 126 are detected by the detector 127. An electron multiplier tube or the like can be used as the detector 127. Note that the ion guide 20 can also be used as the collision cell 126.

### <Configuration Example of Ion Guide 20>

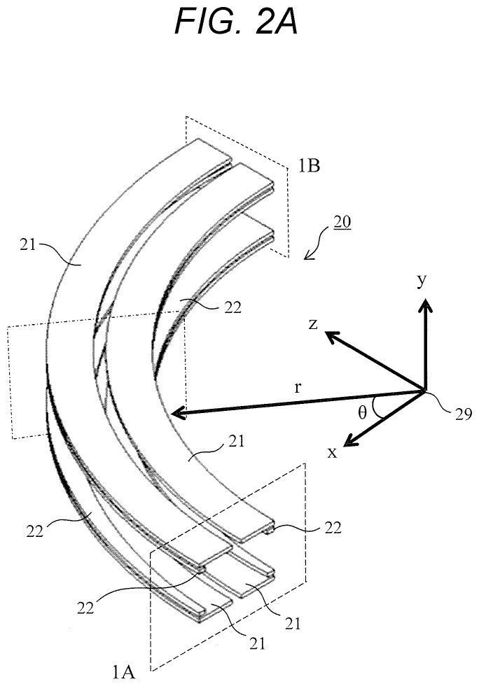

FIG. 2 is a diagram illustrating a configuration example of the ion guide according to the first embodiment. FIG. 2A is a diagram illustrating an external configuration example of the ion guide 20. FIG. 2B is a diagram illustrating a cross-sectional configuration example of the ion guide 20 along a center axis 23. FIG. 2C is a diagram illustrating a cross-sectional configuration example of an inlet 1A and an outlet 1B of the ion guide 20.

As illustrated in FIG. 2A, the ion guide 20 has a curved shape (is a curved ion guide). The ion guide 20 includes two upper multipole electrodes 21 and two lower multipole electrodes 21 that have a plate shape, and two upper axial field electrodes 22 and two lower axial field electrodes 22 held between the upper and lower multipole electrodes. Ions enter from the inlet 1A, and accelerated ions are discharged from the outlet 1B.

The ion guide 20 is configured such that the center axis 23 forms a quarter arc about an ion guide arc center 29. As can be seen from FIG. 2A, the cross-section of the inlet 1A of the ion guide 20 is on the x axis and the cross-section of the outlet 1B is on the z axis. Here, an angle formed between the radius r of the quarter arc and the x axis during the movement of the radius r along the center axis 23 is defined as θ. The length of the axial field electrode 22 in the direction of the distance r (r-axis direction) from the ion guide arc center in the cross section perpendicular to the ion guide center axis 23 varies as a function of the angle θ from the ion guide arc center 29 of the ion guide 20. That is, the axial field electrode 22 is configured such that the cross-sectional area thereof increases from the inlet 1A toward the outlet 1B. It can also be seen from FIG. 2B that the size (on the xz plane) of the axial field electrode 22 decreases from the inlet 1A to the outlet 1B.

The potential formed on the center axis (ion guide center axis) 23 of the ion guide 20 by the axial field electrode 22 depends on the area of the axial field electrode 22 visible from the ion guide center axis 23. Thus, an axial electric field corresponding to the potential difference between the potential of the multipole electrode 21 and the potential of the axial field electrode 22 is formed on the ion guide center axis 23. In FIG. 2C, the signs “+” and “−” indicate the phases of RF voltages applied from the ion guide power supply 300 to the multipole electrode 21 and the axial field electrode 22. RF voltages of the same phase and the same frequency are applied to the electrodes denoted by the same reference signs. In order to generate a multipole electric field that traps ions, an RF voltage opposite in phase to the adjacent multipole electrode 21 is applied to the multipole electrode 21. An RF voltage having the same phase and substantially the same amplitude as those of the RF voltage applied to the adjacent multipole electrode 21 is applied to the axial field electrode 22. By applying voltages in this manner, no potential difference of the RF voltage is generated in spacing, which is narrow, between the multipole electrode 21 and the axial field electrode 22, and thus, electric discharge can be prevented. Different offset DC voltages are applied to the set (pair) of multipole electrodes 21 and the set (pair) of axial field electrodes 22. The area of the cross section perpendicular to the center axis 23 of the axial field electrode 22 visible from the center axis 23 varies according to the distance on the center axis 23. Thus, the intensity of the DC voltage of the axial field electrode 22 received by the ions, which pass through the center axis 23 of the ion guide 20, on the center axis 23 changes. This accelerates the ions.

### <Configuration Example of Ion Guide Power Supply 300>

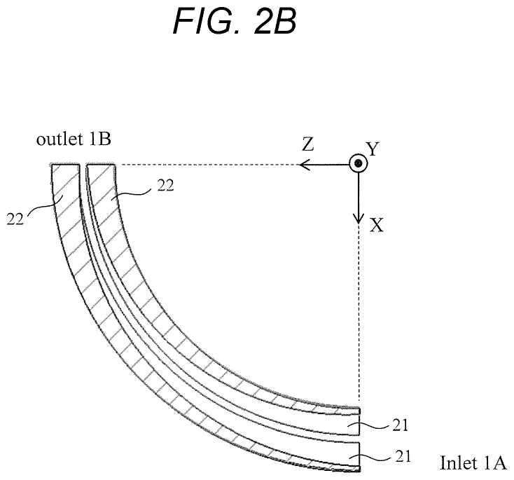

FIG. 3 is a diagram illustrating a configuration example of the ion guide power supply 300 used in each embodiment. FIG. 3 illustrates two types of configuration examples of the ion guide power supply 300.

The ion guide power supply 300 according to any configuration example includes an axial field electrode DC power supply 301, a multipole electrode DC power supply 302, and an RF power supply 303. The ion guide power supply 300 supplies a DC voltage from the axial field electrode DC power supply 301 or the multipole electrode DC power supply 302 to the multipole electrodes 21 and the axial field electrodes 22. The RF power supply 303 includes an AC power supply and a plurality of coils. The RF power supply 303 applies RF voltages having the same phase and the same amplitude to the multipole electrodes 21 and the axial field electrodes 22 using the coils.

### <State of Pseudo Potential>

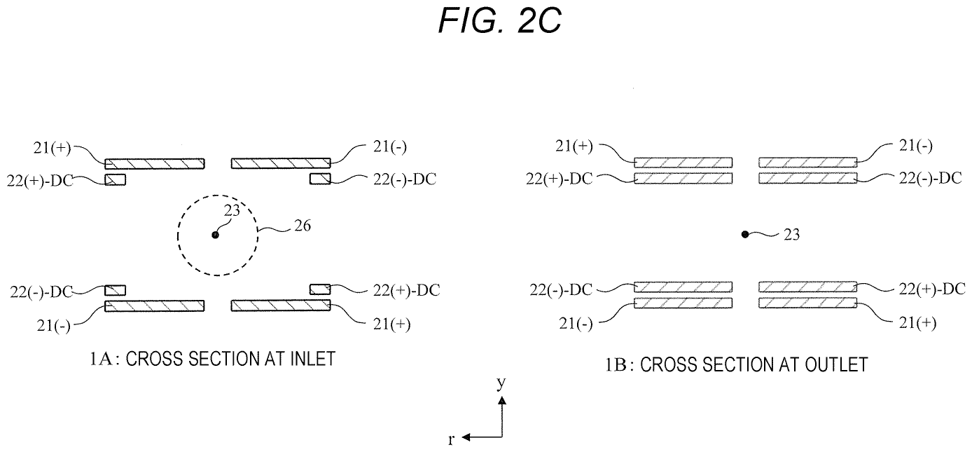

FIG. 4 is a diagram illustrating a pseudo potential on a ry plane at the inlet 1A and the outlet 1B of the ion guide 20. In FIG. 4, the pseudo potential is measured with the m/z of ions of 600 and an RF voltage amplitude of 300 V0-peak.

A RF voltage is applied to the axial field electrode 22, the RF voltage having the same phase and substantially the same amplitude as those of the RF voltage applied to the multipole electrode 21 adjacent to the axial field electrode 22. Thus, a multipole is formed by a set of the multipole electrode 21 and the adjacent axial field electrode 22. Therefore, the axial field electrode 22 does not block the multipole electrode 21, so that pseudo potential distortion is less likely to occur.

At the ion guide inlet 1A, the length of the axial field electrode 22 in the r-axis direction is shorter (the electrode width is smaller) and the distance from the ion guide center axis 23 is longer than those at the ion guide outlet 1B, so that the pseudo potential becomes shallower. Thus, the potential has a funnel shape in which the pseudo potential is deeper with nearness to the ion guide outlet 1B. As a result, the distribution of ions can be efficiently focused.

In the mass spectrometry device 10, charged droplets, neutral contaminants, and the like are introduced into the vacuum chamber together with ions. This causes contamination of the inside of the device. In this regard, the charged droplets and neutral contaminants having a large mass are hardly affected by the electric field, and thus, travel straight in the z-axis direction in FIG. 2 from the aperture 112 in front of the inlet 1A of the ion guide 20. On the other hand, the ions introduced from the inlet 1A of the ion guide 20 are focused to the vicinity of the minimum point of the pseudo potential on the center axis 23, move along the center axis 23, and are discharged from the outlet 1B of the ion guide 20.

In the ion guide 20 illustrated in FIG. 2, the inlet 1A is on the xy plane and the outlet 1B is on the yz plane. Therefore, charged droplets and neutral contaminants travel straight in the z-axis direction from the inlet 1A of the ion guide 20 and are ejected from the ion guide 20, and only ions pass through the ion guide 20. Accordingly, noise can be reduced.

The charged droplets and neutral contaminants introduced through the aperture 112 spread in a range of about several mm and travel straight in the z-axis direction as illustrated in FIG. 2. On the other hand, in the ion guide 20, there is no electrode in a region through which charged droplets and neutral contaminants pass in front of the inlet 1A (in the z-axis direction), and a wide clearance (space) is formed. Therefore, the electrodes (the multipole electrodes 21 and the axial field electrodes 22) are less likely to be contaminated due to collision of neutral contaminants and charged droplets with the electrodes. Thus, the ion guide 20 is resistant to contamination.

### <State of DC Potential>

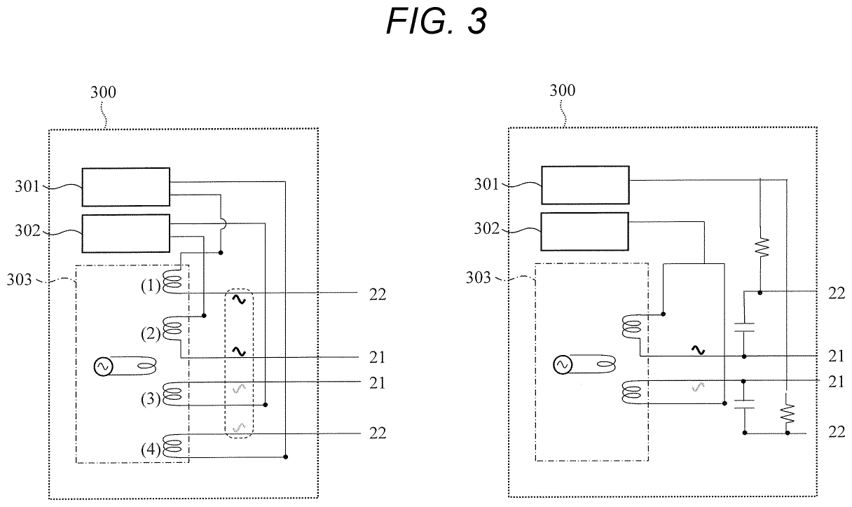

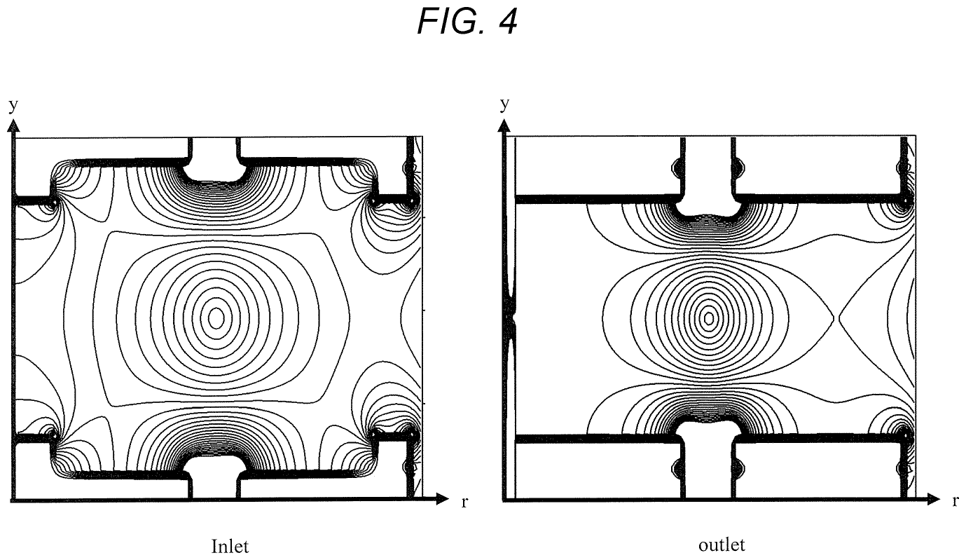

FIG. 5 is a diagram illustrating a DC potential on an xz plane including the center axis 23 of the ion guide 20. FIG. 6 is a diagram illustrating a potential (function of θ in FIGS. 2 and 5) on the center axis 23 of the ion guide 20. Note that the DC potential is calculated assuming that the potential difference between the axial field electrode 22 and the multipole electrode 21 is 10 V.

As can be seen from FIG. 5, the DC potential on the xz plane is dense near the inlet 1A and sparse near the outlet 1B. Thus, the DC potential is the highest at the inlet 1A of the ion guide 20 and gradually decreases toward the outlet 1B of the ion guide 20. As can be seen from FIG. 6, the potential decreases approximately proportional to the angle θ from the center of curvature along the center axis 23 of the ion guide 20. Due to the potential on the center axis 23, ions can always be accelerated at a constant acceleration.

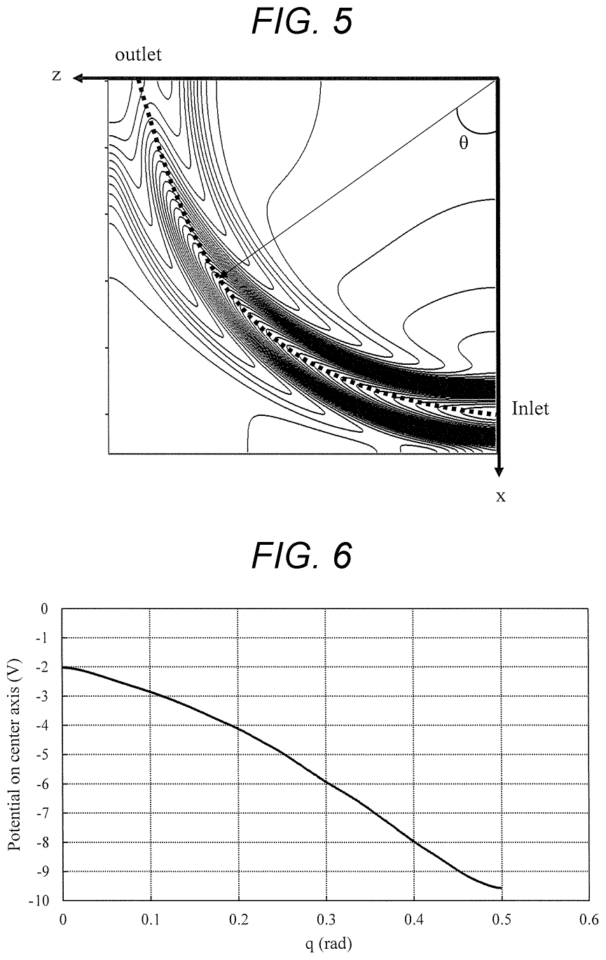

FIG. 7 is a diagram illustrating DC potential on a yr plane at the inlet 1A and the outlet 1B of the ion guide 20. Referring to FIG. 7, it can be seen that the potential at the inlet 1A of the ion guide 20 includes a component of a higher-order pole such as an octupole in addition to a quadrupole. Therefore, due to the effect of the higher-order term, it is possible to efficiently transmit ions having a wide m/z range as compared with a case where the quadrupole DC potential is applied. On the other hand, it can be seen that the DC potential on the yr plane is substantially uniform at the outlet 1B of the ion guide 20, because the multipole electrode is covered with the axial field electrode. Therefore, due to the DC potential, ions do not spread in the spatial distribution, and the spatial distribution of ions can be focused.

<Distribution of Ion Transmission Time: Simulation Result>

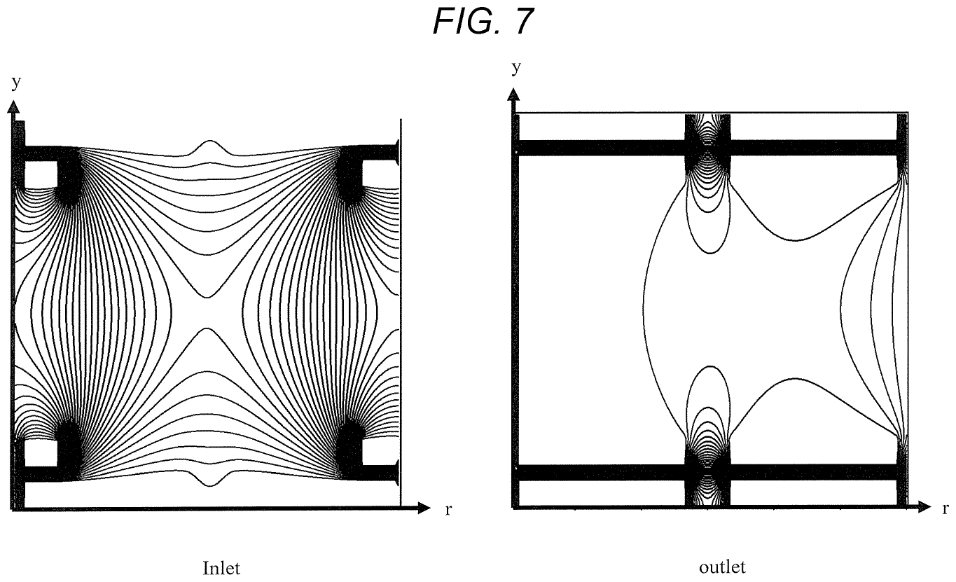

In order to verify the technical effect of the ion guide 20, the transmission time was confirmed by simulation. FIG. 8 is a diagram illustrating the distribution of transmission times of 200 ions for each of conditions where the potential difference is 6 V, 3 V, 1.5 V, and 1 V between the axial field electrode 22 and the multipole electrode 21. Table 1 shows parameter values other than the potential difference between the axial field electrode 22 and the multipole electrode 21.

TABLE 1

| Parameter | Value |
|---|---|
| Pressure | 1.33 (Pa) |
| Collisional cross section area | 2.8E−18 (m²) |
| RF frequency | 1.5 MHz |
| RF amplitude | 300 V₀₋ₚₑₐₖ |
| Gas type | Nitrogen |
| Grid | 0.01 mm/gu |

As can be seen from FIG. 8, the larger the potential difference between the axial field electrode 22 and the multipole electrode 21, the shorter the transmission time and the narrower the half width of the time distribution. That is, according to the simulation, the transmission time is 1 ms or less at a potential difference of 3 V or more between the axial field electrode 22 and the multipole electrode 21, and the transmission time is shortest at a potential difference of 6 V.

From the above, the ion guide 20 can decrease the transmission time by accelerating ions by the electric field formed on the center axis 23, and can avoid the crosstalk of signals.

### <m/z Range of Ions: Simulation Result>

In order to verify the technical effect of the ion guide 20, the m/z range of ions that can stably pass through the ion guide 20 was confirmed by simulation. The lower limit of m/z of ions that can stably pass through the ion guide 20 is determined by a low mass cut off value (LMCO) that is the lower limit of the stability region of the Mathieu equation. For example, when a quadrupole electrode is used, the LMCO of a monovalent ion is given by the following Expression (1).

$$\begin{matrix}[ Expression 1 ] & \\ {m}_{LMCO} = \frac{4 eV}{{q}_{LMCO} {r}_{0}^{2} {Ω}^{2}} = 4.4 \frac{eV}{{r}_{0}^{2} {Ω}^{2}} & ( 1 )\end{matrix}$$

Here, V represents a RF voltage amplitude, m represents a mass of an ion, q_{LMCO} represents a q value of a Mathieu equation in LMCO, e represents an elementary charge amount, Q represents a RF voltage frequency, and r₀ represents the radius of a circle inscribed in a quadrupole. It can be seen from Expression (1) that the lower limit of m/z of ions that can stably pass through the ion guide 20 increases as the RF voltage amplitude increases.

On the other hand, the upper limit of m/z of ions that can pass through the ion guide is determined by the relationship between the pseudo potential (Ψ) of monovalent ions and the effect of ejecting ions by the DC potential represented by Expression (2).

$$\begin{matrix}[ Expression 2 ] & \\ Ψ = \frac{e}{4 m {Ω}^{2}} {E}^{2} & ( 2 )\end{matrix}$$

Here, E represents an electric field. It can be seen from Expression (2) that, since the pseudo potential is inversely proportional to m/z of ions, ions having a high m/z range have a low pseudo potential and are ejected by the DC potential. Since the pseudo potential increases as the RF voltage amplitude increases, the upper limit of m/z of ions that can pass increases.

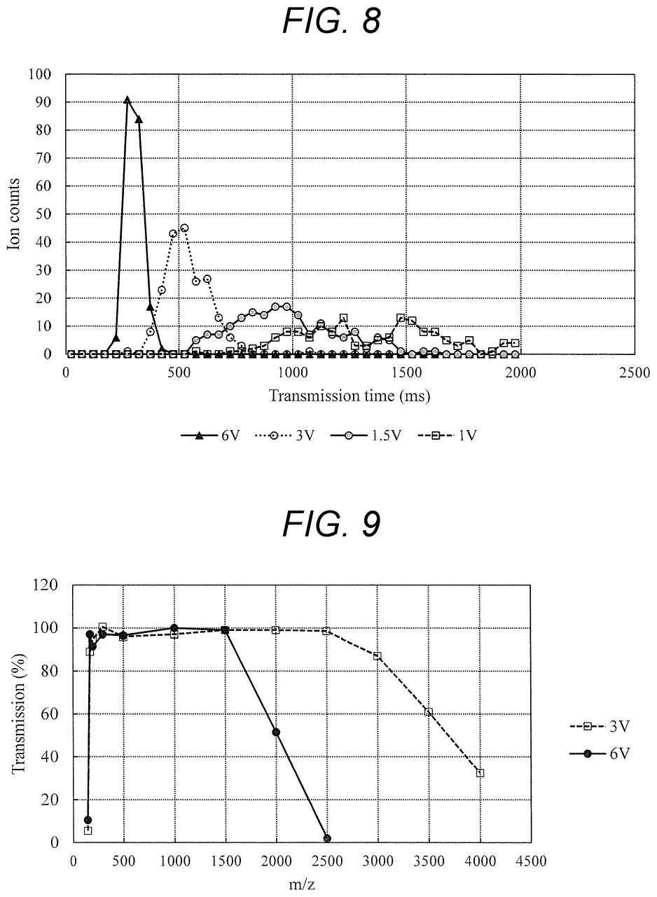

FIG. 9 is a diagram illustrating the transmittance of ions having m/z of 150 to 4000 under conditions where the potential difference between the axial field electrode 22 and the multipole electrode 21 is 3 V and 6 V. When the potential difference between the axial field electrode 22 and the multipole electrode 21 was 3 V, an average transmittance of 97% was obtained for ions having m/z of 175 to 2500, that is, ions in the range from LMCO to LMCO×14.3. When the potential difference between the axial field electrode 22 and the multipole electrode 21 was 6 V, an average transmittance of 97% was obtained for ions having m/z of 175 to 1500, that is, ions in the range from LMCO to LMCO×8.6.

As described above, the ion guide 20 according to the present embodiment can transmit ions in a wide m/z range. In addition, in the ion guide 20 according to the present embodiment, the multipole electrode 21 and the axial field electrode 22 both are plate-shaped electrodes. Thus, there is a degree of freedom in the configuration of the ion guide 20 from the viewpoint of ease of manufacture, and the ion guide 20 can be formed to have a half arc or a more complicated channel shape with the same design concept. Therefore, the ion guide 20 can be flexibly mounted according to the footprint (bottom area) and the shape of the mass spectrometry device 10 in the future.

### (2) Second Embodiment

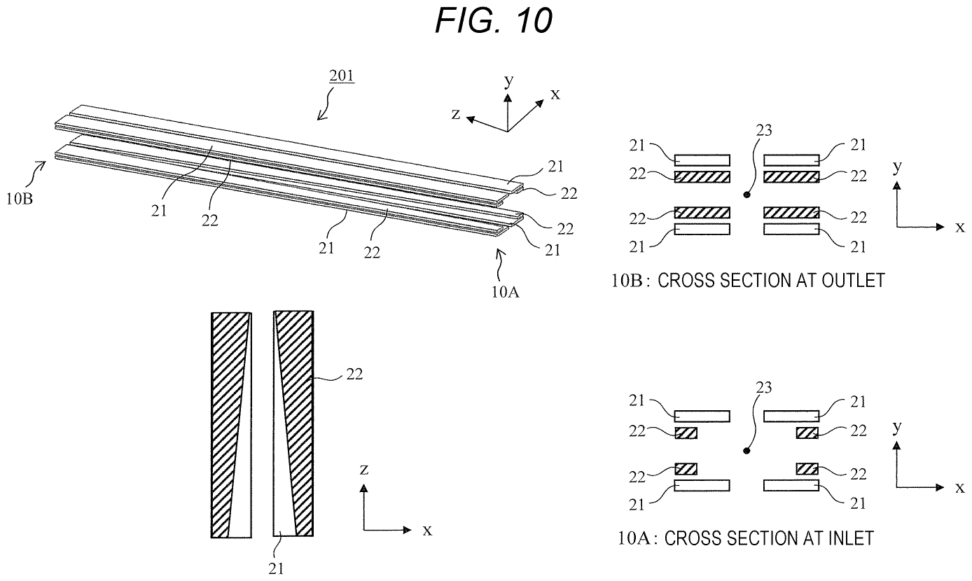

FIG. 10 is a diagram illustrating a schematic configuration example of an ion guide 201 according to a second embodiment. The ion guide 201 has a linear shape and includes a multipole electrode 21 and an axial field electrode 22. The ion guide 201 is configured such that the length in the x direction of the axial field electrode 22 forming an axial electric field is shorter at an inlet 10A (a cross-sectional area of the electrode is smaller) and longer at an outlet 10B (a cross-sectional area of the electrode is larger). Note that the configuration of the ion guide 201 in the radial cross section, the pseudo potential, the DC potential, and the potential on the center axis 23 are similar to those in the first embodiment. The ion guide 201 having a linear shape has a simpler structure than the ion guide 20 according to the first embodiment, and can be manufactured at lower cost. On the other hand, since the direction in which the ions enter the ion guide 201 and the direction in which the ions are discharged from the ion guide 201 are the same, the effect of reducing noise is smaller than that in the first embodiment.

### (3) Third Embodiment

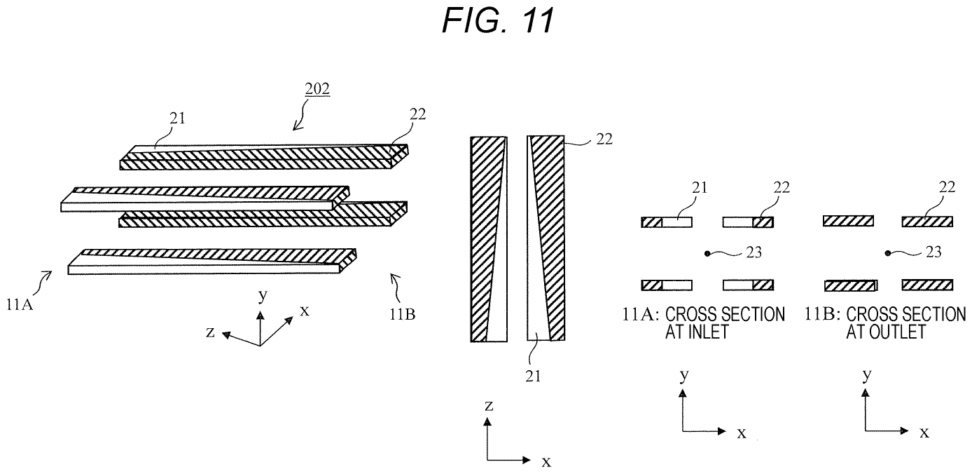

FIG. 11 is a diagram illustrating a schematic configuration example of an ion guide 202 according to a third embodiment. In the ion guide 202, a multipole electrode 21 and an axial field electrode 22 are in the same xz plane. That is, in the first and second embodiments, the ion guide 20 or 201 is configured by arranging the multipole electrode 21 and the axial field electrode 22 so as to spatially overlap each other in the z-axis direction (see FIGS. 2A and 2B and FIG. 10). On the other hand, in the third embodiment, the ion guide 202 is configured by using four substantially rectangular flat plate electrodes (a pair of upper electrodes and a pair of lower electrodes) obtained by bonding the multipole electrode 21 having a trapezoidal or triangular flat plate and the axial electric field electrode 22 having a trapezoidal or triangular shape on the side surface (bonding the short side (vertex) side and the long side (base) side together). Alternatively, both electrodes may be arranged with the side surfaces facing each other without being bonded to each other, and four plate electrodes (a pair of upper electrodes and a pair of lower electrodes) having apparently a rectangular shape may be prepared. The ion guide 202 may be configured using the four plate electrodes.

Referring to FIG. 11, in the ion guide 202, the length (electrode width in the x direction) of the multipole electrode 21 in the x direction is longer at an inlet 11A and shorter at an outlet 11B of the ion guide 202. The length in the x direction (electrode width in the x direction) of the axial field electrode 22 is shorter at the inlet 11A and longer at the outlet 11B of the ion guide 202. With such an electrode configuration, an axial electric field is formed.

In the ion guide 202 according to the third embodiment, the multipole electrode 21 and the axial field electrode 22 are on the same plane (xz plane). Thus, the spacing between the electrodes in the y-axis direction is wider than that of the ion guide 20 according to the first embodiment. Therefore, the charged droplets and neutral contaminants that have entered hardly collide with the electrodes, whereby the ion guide 202 is resistant to contamination. On the other hand, the depth of the pseudo potential along the center axis 23 is constant, and the efficiency of converging ions is relatively low (as compared with the first embodiment).

### (4) Fourth Embodiment

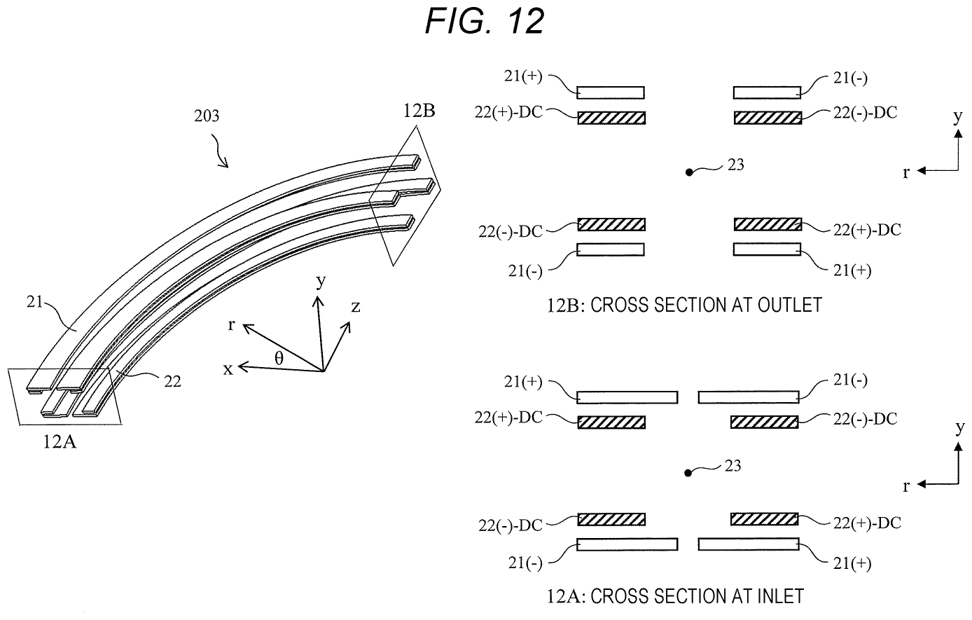

FIG. 12 is a diagram illustrating a configuration example of an ion guide 203 according to a fourth embodiment. The ion guide 203 is configured such that the width in the r-axis direction (xz plane) of an axial field electrode 22 is constant, and the width in the r-axis direction (xz plane) of a multipole electrode 21 varies according to the position on the ion guide center axis.

The potential formed by the multipole electrode 21 on the center axis 23 of the ion guide 203 depends on the area of the multipole electrode 21 visible from the center axis 23 of the ion guide 203. Therefore, an axial electric field corresponding to a potential difference between the multipole electrode 21 and the axial field electrode 22 is formed on the center axis 23 of the ion guide 203.

### (5) Fifth Embodiment

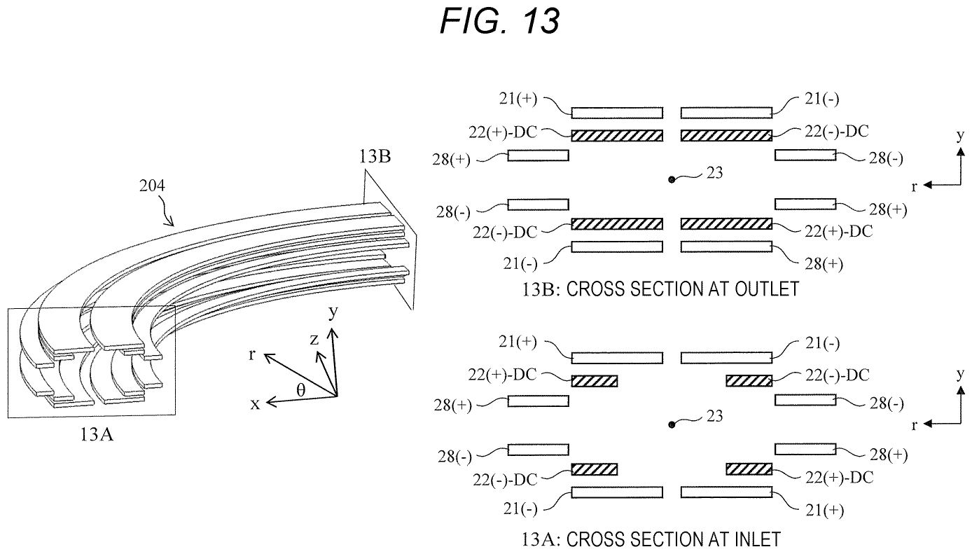

FIG. 13 is a diagram illustrating a configuration example of an ion guide 204 according to a fifth embodiment. In addition to the components of the ion guide 20 according to the first embodiment, the ion guide 204 includes a second multipole electrode (additional multipole electrode) at a position closer to the center axis 23 with respect to the axial field electrode 22. The same voltage is applied to the first multipole electrode 22 and the second multipole electrode 28.

The ion guide 204 is somewhat more complex in configuration than the ion guide 20 according to the first embodiment, but the DC potential at an inlet 13A of the ion guide 204 approaches a higher-order multipole. For this reason, the ion guide 204 has an advantage that the m/z range of ions that are to pass is wider than that of the ion guide 20 according to the first embodiment.

### (6) Summary of Embodiments

The features of the embodiments will be summed up as follows. Specifically, the feature of the ion guide according to the present disclosure is that the cross-sectional area perpendicular to the center axis of the ion guide (20, 201 to 204) of at least one of a multipole electrode 21 or an axial field electrode 22 varies from an inlet (1A, 10A, 11A, 12A, and 13A) to an outlet (1B, 10B, 11B, 12B, and 13B) of the ion guide.
(i) According to the first embodiment, the cross-sectional area, perpendicular to the center axis 23 of the ion guide, of the axial field electrode 22 varies (increases) from the inlet 1A to the outlet 1B of the ion guide 20. As a result, it is possible to obtain a funnel potential in which the pseudo potential is deeper with nearness to the ion guide outlet 1B, and thus, the distribution of ions can be efficiently focused. As illustrated in FIG. 2C, two pairs of the multipole electrodes 21 and two pairs of the axial field electrodes 22 are disposed as plate-shaped electrodes. The multipole electrode and the axial field electrode both have an arc shape extending from the inlet to the outlet (curved electrode). Specifically, the inlet 1A is on the xy plane and the outlet 1B is on the yz plane. Therefore, charged droplets and neutral contaminants travel straight in the z-axis direction from the inlet 1A of the ion guide 20 and are ejected from the ion guide 20, and only ions pass through the ion guide 20. Accordingly, noise can be reduced. RF voltages having the same phase and the same amplitude are applied to the multipole electrodes 21 by the ion guide power supply 300. Different DC voltages are applied to generate a potential difference between the multipole electrodes 21 and the axial field electrodes 22. By applying voltages in this manner, no potential difference of the RF voltage is generated in spacing, which is narrow, between the multipole electrode 21 and the axial field electrode 22, and thus, electric discharge can be prevented.

In addition, as can be seen from FIG. 6, the potential decreases approximately proportional to the angle θ from the center of curvature along the center axis 23 of the ion guide 20. Due to the potential on the center axis 23, ions can always be accelerated at a constant acceleration. On the other hand, the DC potential on the yr plane is substantially uniform at the outlet 1B of the ion guide 20, because the multipole electrode is covered with the axial field electrode. Therefore, due to the DC potential, ions do not spread in the spatial distribution, and the spatial distribution of ions can be focused. As described above, ions in a wide m/z range can be transmitted using the ion guide 20.
(ii) According to the second embodiment, the cross-sectional area of the axial field electrode 22 perpendicular to the center axis 23 of the ion guide increases from the inlet 10A to the outlet 10B of the ion guide 201 as in the first embodiment, and the multipole electrode 21 and the axial field electrode 22 both have a linear shape. Even when the ion guide 201 according to the second embodiment is used, a technical effect similar to that of the first embodiment can be expected (the voltage application is similar to that of the first embodiment).
(iii) According to the third embodiment, the plate-shaped axial field electrode 22 is configured such that the cross-sectional area perpendicular to the center axis 23 increases from the inlet 11A to the outlet 11B, and the plate-shaped multipole electrode 21 is configured such that the cross-sectional area decreases from the inlet 11A to the outlet 11B (see FIG. 11). The axial field electrode 22 and the multipole electrode 21 are disposed on the same plane such that side surfaces thereof face each other (are bonded to each other on the side surfaces or are arranged side by side in the same plane (xz plane)). With this configuration, a technical effect similar to that of the first embodiment can be expected (the voltage application is similar to that of the first embodiment).
(iv) According to the fourth embodiment, the axial field electrode 22 is configured such that the cross-sectional area perpendicular to the center axis 23 of the ion guide is constant from the inlet 12A to the outlet 12B, and the multipole electrode 21 is configured such that the cross-sectional area increases from the inlet 12A to the outlet 12B (see FIG. 12). Due to the configuration in which the multipole electrode 21 is relatively larger than the axial field electrode 22 (the multipole electrode 21 covers the axial field electrode 22) as described above, a technical effect similar to that of the first embodiment can be expected (the voltage application is similar to that of the first embodiment).
(v) According to the fifth embodiment, the cross-sectional area, perpendicular to the center axis 23 of the ion guide, of the axial field electrode 22 located closer to the center axis 23 with respect to the multipole electrode 21 increases from the inlet 1A to the outlet 1B of the ion guide 20, and the multipole electrode 21 is disposed to cover the axial field electrode 22 (the configuration described above is the same as that of the first embodiment). Further, the additional multipole electrode 28 is provided at a position closer to the center axis 23 with respect to the axial field electrode 22. This makes it possible to further increase the m/z range of ions that are to pass.
(vi) Note that the description of each of the above embodiments is merely an example, and does not limit the technology of the present disclosure, and various modifications are conceivable. For example, the above-described embodiments have been described in detail for easy understanding of the technology of the present disclosure, and are not necessarily limited to those having all the described configurations. Further, a part of the configuration of one embodiment can be replaced with the configuration of another embodiment, and the configuration of another embodiment can be added to the configuration of one embodiment. In addition, it is possible to add, delete, and replace other configurations for a part of the configuration of each embodiment.

### REFERENCE SIGNS LIST

20, 201, 202, 203, 204 ion guide
21 multipole electrode
22 axial field electrode
23 ion guide center axis
28 second multipole electrode (additional multipole electrode)
29 ion guide arc center of center axis
101 ion source
102 first differential pumping section
103 second differential pumping section
104 mass spectrometry chamber
111, 112, 113 aperture
121 ion guide (for transporting ions)
125 mass filter
126 collision cell
131, 132, 133 vacuum pump
300 ion guide power supply
301 axial field electrode DC power supply
302 multipole electrode DC power supply
303 RF power supply

1. An ion guide into which ions are introduced and which is configured to focus and discharge the ions, the ion guide comprising:
a multipole electrode for forming a multipole electric field; and
an axial field electrode for forming an axial electric field, wherein
a cross-sectional area perpendicular to a center axis of the ion guide of at least one of the multipole electrode or the axial field electrode varies from an inlet to an outlet of the ion guide.

2. The ion guide according to claim 1, wherein
the cross-sectional area of the axial field electrode increases from the inlet to the outlet.

3. The ion guide according to claim 1, comprising
two pairs of the multipole electrodes and two pairs of the axial field electrodes, wherein
the multipole electrodes and the axial field electrodes both have a plate shape.

4. The ion guide according to claim 3, wherein
the multipole electrodes and the axial field electrodes have an arc shape from the inlet to the outlet.

5. The ion guide according to claim 3, wherein
the multipole electrodes and the axial field electrodes have a linear shape.

6. The ion guide according to claim 1, wherein
the cross-sectional area of the axial field electrode is constant from the inlet to the outlet, and
the cross-sectional area of the multipole electrode increases from the inlet to the outlet.

7. The ion guide according to claim 3, wherein
the multipole electrodes are disposed to cover the axial field electrodes.

8. The ion guide according to claim 1, wherein
the axial field electrode has a plate shape and is configured such that the cross-sectional area increases from the inlet to the outlet,
the multipolar electrode has a plate shape and is configured such that the cross-sectional area decreases from the inlet to the outlet, and
the axial field electrode and the multipole electrode are disposed on a same plane with side surfaces of the axial field electrode and the multipole electrode facing each other.

9. The ion guide according to claim 1, wherein
the axial field electrode is disposed at a position closer to the center axis with respect to the multipole electrode,
the ion guide further comprising an additional multipole electrode different from the multipole electrode, the additional multipole electrode being disposed at a position closer to the center axis with respect to the axial field electrode.

10. A mass spectrometry device comprising:
an ion source configured to generate ions;
the ion guide according to claim 1, the ion guide being disposed at a subsequent stage of the ion source and configured to focus the ions;
an ion guide power supply configured to apply a voltage to the ion guide; and
a detector configured to detect the ions focused by the ion guide, wherein
the ion guide power supply is configured to apply RF voltages of a same phase and a same amplitude to the axial field electrode and the multipole electrode, and apply different DC voltages so as to generate a potential difference between the multipole electrode and the axial field electrode.

11. A mass spectrometry device comprising:
an ion source configured to generate ions;
the ion guide according to claim 9, the ion guide being disposed at a subsequent stage of the ion source and configured to focus the ions;
an ion guide power supply configured to apply a voltage to the ion guide; and
a detector configured to detect the ions focused by the ion guide, wherein
the ion guide power supply is configured to apply RF voltages of a same phase and a same amplitude to the multipole electrode and the additional multipole electrode, and apply different DC voltages so as to generate a potential difference between the multipole and additional multipole electrodes and the axial field electrode.
